(19) United States
(12) Patent Application Publication
(10) Pub. No.: US 2023/0302773 A1
(43) Pub. Date: Sep. 28, 2023

(54) Window module, motor vehicle having such a window module and roof module having such a window module

(71) Applicant: Webasto SE, Stockdorf (DE)

(72) Inventors: Jan GROTHE, Stockdorf (DE); Rudolf DIETL, Stockdorf (DE); Stefan GROITL, Stockdorf (DE); Franz ZACHERL, Stockdorf (DE); Guido BOTT, Stockdorf (DE)

(21) Appl. No.: 18/188,608

(22) Filed: Mar. 23, 2023

(30) Foreign Application Priority Data
Mar. 28, 2022 (DE) 10 2022 107 267.3

(51) Int. Cl. B32B 17/10; B62D 25/06; B32B 7/027; B32B 7/12; B32B 27/40; B32B 27/28; B32B 3/26; B32B 5/18; B32B 5/02; B32B 27/06; B32B 27/12; B32B 3/30; B32B 7/08

(52) U.S. Cl. CPC B32B 17/1077; B62D 25/06; B32B 7/027; B32B 7/12; B32B 27/40; B32B 27/283; B32B 3/266; B32B 5/18; B32B 5/02; B32B 27/065; B32B 27/12; B32B 3/30; B32B 7/08; B32B 17/10495; B32B 17/10798; B60J 3/007

(57) ABSTRACT

A window module, in particular a fixed transparent window module, for being fitted on a vehicle body which has a body frame, which at least partially defines a roof opening and on which a peripheral supporting receptacle for receiving the window module is formed, having at least one at least partially transparent window, which has an outer surface facing a vehicle environment and an inner surface opposite the outer surface and facing a vehicle interior, wherein at least one plastic structure, which is at least configured as a burn protection for at least one vehicle occupant, is disposed on the to inner surface.

### CROSS-REFERENCE TO RELATED APPLICATION

This application claims priority from German Patent Application Number DE 10 2022 107 267.3, filed on Mar. 28, 2022, which is hereby incorporated herein by reference in its entirety for all purposes.

### FIELD

The invention relates to a window module, in particular a fixed transparent window module, according to the preamble of claim 1. Furthermore, the invention relates to a motor vehicle having such a window module.

### BACKGROUND

Generic window modules are known from the state of the art and are often referred to as fixed transparent modules, FTM for short. The known window modules preferably form large (glass) roofs and are disposed on or fastened to an edge portion of a vehicle body roof frame, for example. A fastening of this kind can be effected, for example, by gluing the window module, in particular by gluing the window to the vehicle body. It is also known to cover the edge of the window with polyurethane foam in order to connect it to the vehicle body shell. It is also known to cover further fastening elements for fastening the window to the vehicle body shell, in particular at the edge portion of the window with foam. Known are polyurethane-based foaming processes for tempered glass, semi-tempered glass and/or laminated safety glass.

Window modules of this kind preferably have at least one transparent glass window which allows a vehicle occupant or backseat passengers to fully see a vehicle environment. So far, a glass window of this kind has been dimensioned such that the backseat passengers sit under a mostly concealed headliner. In this case, there is often only a limited space between the head of a backseat passenger and the window of the window module and/or other vehicle body parts. Driven by this, safety requirements necessitate the provision of an impact protection in order to soften the impact in the event of a collision with the head of a backseat passenger, for example, so that injuries are avoided. By providing an impact protection of this kind, which, as a side cover, commonly covers an edge area between a roof frame of the vehicle body and the at least one window, applicable head impact regulations can be adhered to.

With new vehicle designs, head impact protection can increasingly be dispensed with, since rear passengers will continue to be positioned directly below the glass window, but at least have a safe (impact) distance to it measured by their head. Even though designs of this kind do not require impact protection, known window modules are still subject to a significant risk of burns. For example, solar irradiation or exposure to the sun can heat up the transparent (glass) window of the window module to temperatures of above 100° C., for example 105° C. on a hot summer's day. If a backseat passenger, for example when entering or exiting, comes into contact with an inner surface of the window facing the vehicle interior with their head or another body part, it can cause severe burns in some cases. Such risks of burns must be avoided.

One technical approach to preventing the risk of contact-related burns is to also provide the inner surface of the window with an appropriate protective coating. Protective coatings of this kind are known in particular for semi-tempered glass and/or laminated safety glass. However, it has been discovered that known coatings are not sufficient for sustainably reducing the risk of burns.

### SUMMARY

An object of the invention is therefore (to be seen in) proposing a window module which evades the disadvantages of the known state of the art described above and, in particular, reduces a risk of burns for a vehicle occupant from a hot window.

This object is attained by a window module according to the teachings of claim 1. Furthermore, the object is attained by a motor vehicle having an embodiment of a window module according to the invention. In addition, the object is attained by a roof module having an embodiment of a window module according to the invention.

Advantageous embodiments of the invention are the subject matter of the dependent claims. Moreover, any and all combinations of at least two features disclosed in the description, the claims, and/or the figures fall within the scope of the invention. Naturally, the explanations given in connection with the window module equivalently relate to the motor vehicle according to the invention and vice-versa, albeit not verbatim.

The window module according to the invention describes in particular a fixed transparent (window) module, also named fixed transparent module (FTM). The window module is intended for being fitted on a vehicle body. The vehicle body has a body frame by means of which a roof opening is defined at least partially and on which a peripheral, in particular circumferential, supporting receptacle for receiving the window module is formed. The window module according to the invention comprises at least one at least partly transparent window, which has an outer surface facing a vehicle environment and an inner surface opposite the outer surface and facing a vehicle interior. The window module is characterized in that at least one plastic structure, which is at least configured as a burn protection for at least one vehicle occupant, is disposed on the inner surface.

By providing the at least one plastic structure, it is possible to effectively prevent a direct contact, for example between a backseat passenger's head and/or limb and the inner surface of the least one (glass) window, according to the invention. This in turn makes it possible to avoid the risk of burns that would potentially exist if the inner surface of the window were touched, compared with the state of the art. Instead, the vehicle occupant might “only” come into direct contact with the plastic structure. However, since the plastic structure is designed as a burn protection, direct contact with the plastic structure will not cause any burns. Instead, the temperature of a boundary layer on a surface of the plastic structure is low enough, preferably <60° C., particularly preferably <45° C. For its intended use, i.e., for providing a burn protection, the plastic structure is preferably provided within a see-through portion of the at least one window and/or disposed at least in an edge portion around the window.

In particular, the plastic structure is not to be confused with other components disposed in particular in a roof area of the passenger compartment (also referred to as the backseat), for example a sun visor or an interior lining or the like, because components of this kind are not intended to be used to prevent the danger of a (skin) burn of a vehicle occupant. In addition to the protection against burns, the invention allows a high design flexibility because the at least one plastic structure can be dimensioned and/or formed in various ways. According to the invention, it is also possible to forgo the coating for reducing the surface temperature of the inner surface of the window known from the state of the art. However, it is also generally conceivable that a coating of this kind is provided in addition, in particular as basic protection. Based on the design variety, it is also possible to individualize an aesthetical appearance of the roof portion in the passenger compartment in the production of the plastic structure and to customize it according to specific customer wishes, if desired. The solution according to the invention is also characterized by a light weight and a short production time. In addition, no or only a small number of additional components are required to provide the burn protection. According to the invention, it is preferably possible to apply one or several plastic structure(s) in independent areas of the inner surface of the window.

The wording “at least one” means that the window module according to the invention can comprise one or several of the respective components. It is obvious that the window module according to other embodiments can comprise several plastic structures. In addition, it is obvious that the window module can comprise several windows separated from or adjacent to each other. The at least one window is preferably a glass window, in particular made of a tempered glass, semi-tempered glass and/or laminated safety glass and serves for glazing the motor vehicle relative to the vehicle environment. It is obvious that the window module according to the invention can be produced and/or provided irrespective of a vehicle body and can be supplied preferably as a modular unit.

According to a preferred embodiment, the at least one plastic structure has a lower thermal conductivity compared with the at least one window. As a general rule, plastic materials have a lower thermal conductivity than glass. Because of the reduced thermal conductivity, the at least one plastic structure does not heat up as much as the at least one window, which is commonly made of glass. In the case of intensive solar irradiation, this results in a lower surface temperature at a boundary layer of the plastic structure facing the passenger compartment compared to the inner surface of the window, which prevents the burning of a head, for example. For example, according to the invention, it is possible that at a temperature of 100° C. measured on the inner surface of the window, the surface temperature of the at least one plastic structure is preferably <60° C., particularly preferably <45° C. Preferably, a ratio between a thermal conductivity coefficient of the window and a thermal conductivity coefficient of the plastic structure is >1.66, more preferably >2.22.

According to a preferred embodiment, the at least one plastic structure is glued to the inner surface of the at least one window and/or disposed on the inner surface, in particular connected to said inner surface, by foaming and/or overmolding. The plastic structure can be connected to the inner surface preferably directly, i.e., without any intermediate components, or indirectly, i.e., via at least one intermediate component, for example an installation aid. In particular covering the plastic structure with foam for being fitted on the inner surface is a cost-effective solution because the same technique is already used for disposing the window module, in particular the at least one window, on the vehicle body. Thus, the use of the foaming process is already known, so that existing manufacturing know-how can be used. Different colors can also be used in the foaming process to meet design preferences, for example. The burn protection can be integrated in the course of the foaming process. For example, the at least one plastic structure can be applied to the inner surface of the window by a process, such as “RIM” or “Open RIM”. The plastic structure, in particular a plastic (polyurethane) structure thus protects a head or other limbs of the vehicle occupant by preventing direct contact with the inner surface of the window. RIM stands for reaction injection molding and describes the production of plastic injection molded parts made of polyurethane. The method is also known as Low Pressure Molding. A mixing system mixes the A and B components of the PUR material and injects them under pressure into the mold.

According to a preferred embodiment, at least one frit, on which at least one plastic structure is disposed, is formed on the inner surface of the at least one window. The plastic structure can be disposed directly or indirectly on the at least one frit. A (glass) frit is preferably produced by superficially melting glass powder, whereby the glass grains bake together (sintering). Preferably, the frit has a porous surface structure that is particularly suitable as a basis for fitting the at least one plastic structure. In particular in case of adhesion and/or cohesion, but also overmolding and/or foaming, the surface characteristics improve an adhesive strength because of an increased surface area.

According to a preferred embodiment, the inner surface of the at least one window comprises at least a partially pretreated, in particular surface-treated, (surface) portion on which the at least one plastic structure is disposed. The plastic structure can be disposed directly or indirectly on the at least one surface-treated portion. Alternatively or additionally to fastening the plastic structure on a frit, this is an effective way of increasing adhesive strength during gluing and/or overmolding and/or foaming, since, for example, the surface of the inner surface of the window can be roughened and/or scratched and/or superficially etched. All these pretreatment steps preferably serve to increase the surface of the connection point between the plastic structure and the inner surface. This increases the connection strength and the resistance of the connection.

According to a preferred embodiment, the at least one plastic structure is made of a recycled plastic and/or a natural plastic and/or a thermoplastic elastomer and/or polyurethane and/or silicone. Generally, the plastic structure can also be made of another plastic material, so the selection above is not to be understood conclusively. Polyurethane is particularly advantageous if the plastic structure is at least partly transparent, in particular transparent. However, other plastic materials can also provide this transparent property of the plastic structure.

According to a preferred embodiment, the at least one plastic structure comprises a plastic base body which is preferably at least partially transparent, particularly preferably transparent. The plastic base body can preferably serve to shape the plastic structure. The plastic base body can preferably have any shape and be adjusted to predetermined design requirements. The plastic base body can be shaped, for example, by providing a corresponding injection mold. The plastic base body preferably forms a supporting surface to which at least one more layer comprised in the plastic structure can be applied to. A layer of this kind can be a lamination, for example. Laminating means connecting at least two layers of the same or different material(s) using at least one suitable laminating agent. Laminating the plastic base body is preferred, for example, if it is made of a non-transparent recycled and/or natural plastic because it will no longer be visible as a result of the laminating.

According to a preferred embodiment, the plastic base body is perforated and/or foam-filled and/or comprises a guide structure which is in particular structurally stable, preferably over-molded by plastic. Filling the plastic base body with foam is advantageous in that an additional insulation effect is achieved. In addition, a smooth or soft plastic base body of this kind also serves as an impact protection. Perforating the plastic base body is advantageous in that air circulation within the plastic base body is enabled, such that heat can be dissipated better from said plastic base body. This can reduce heating of the plastic base body. The guide structure preferably serves as a guiding frame by means of which the plastic base body receives its basic form. The guide structure is preferably covered by at least one plastic layer or made of plastic. The guide structure is preferably formed from a structurally stable material, such as steel wire, aluminum wire or plastic. With a guide structure of this kind, the base body can also have a complex shape. According to a preferred embodiment, the plastic base body comprises at least one film which is preferably introduced into said base body by an in-mold lamination process. An in-mold lamination of this kind allows the surface of the plastic base body to have various designs and/or patterns by selecting the film accordingly. Particularly preferably, the at least one film has a pattern and/or a coloring and/or an optical filter characteristic. It is possible, for example, to reflect solar irradiation in the area of the plastic structure in the direction of a vehicle environment by means of an appropriate film, such that heating of the plastic structure is reduced. It is also possible to select a film that inhibits or filters UV radiation. This also effectively prevents the plastic structure from heating up.

According to a preferred embodiment, a foam layer and/or a textile layer is/are applied to the plastic base body, in particular glued to said plastic base body. Particularly preferably, a layer of this kind is applied by a, for example, subsequent lamination, in particular by a pressed lamination by means of an edge folding tool. An outer layer on the plastic base body can preferably be designed to match another design of the passenger compartment, for example a lining of a headliner, regarding its haptic and/or optical appearance, in particular regarding its material.

According to a preferred embodiment, the plastic base body is produced using injection molding and/or deep drawing, in particular vacuum forming, and/or 3D printing. Other production methods for producing the plastic base body are also conceivable. 3D printing is particularly advantageous because the design variety is almost unlimited in three dimensions. For example, rib-like structures having inner cavities can be formed in this way, which is almost impossible with other production methods.

According to a preferred embodiment, the plastic base body is rib-shaped and/or duct-shaped and/or grid-shaped and/or net-shaped. This is advantageous in that the supply of natural light is not negatively affected or impaired. A design of this kind is not conspicuous, but still prevents the risk of burns in case of direct contact. In particular, a suitable rib-shaped and/or duct-shaped design keeps the head region of the vehicle occupant away from the inner surface of the window, in particular the glass surface. The preferred rib structure is as thin and delicate as possible, which preferably has internal duct-shaped cavities. Via these cavities, heat can be dissipated to the environment (into the passenger compartment), whereby the plastic structure is prevented from heating up. In other words, the plastic structure is preferably configured to allow air circulation, in particular air transmission. Polyurethane and/or silicone or a thermoplastic elastomer (TPE) are preferably used as materials for the at least one plastic structure, in particular for its base body. Reference is made to known primer procedures.

According to a preferred embodiment, the plastic structure has at least one installation component which is glued and/or screwed to the inner surface of the at least one window and/or disposed on, in particular connected to, the inner surface by foaming and/or overmolding. Preferably, the at least one installation component is configured to receive the plastic base body at least partially, in particular captively. Particularly preferably, at least one installation portion, which can be captively connected to the installation component, is provided at the end of the plastic base body. The plastic base body can be indirectly connected to the inner surface of the window via the installation component. This is advantageous in that merely the at least one installation component and not the entire plastic base body must be disposed on the inner surface. This is a cost-effective solution that can be easily integrated into an existing foaming and/or injection molding and/or gluing process. Furthermore, a design of the plastic base body can be chosen almost freely. Particularly preferably, the plastic base body is disposed on the installation component such that it cannot be detached at all or at least not without the aid of a tool. Thus, the plastic base body is intended to be disposed indirectly on the inner surface so as to be captive as a burn protection. However, the plastic base body is preferably disposed on the at least one installation component such that it can be removed and/or unclipped and/or pivoted for the purpose of cleaning. This facilitates the cleaning. According to the invention, the position of the plastic base body is in particular tamper-proof, such that the plastic base body cannot be used, for example, to store objects or removed by a vehicle occupant without authorization.

According to a preferred embodiment, the plastic base body is in particular captively connected to the at least one installation component via a clip connection and/or a hinged connection. Preferably, a hinge-like installation portion is formed on the installation component. The installation component is preferably disposed on, in particular foamed to, the inner surface such that the installation portion is exposed. Particularly preferably, the installation portion has a socket. A complementary installation area is preferably formed on the plastic base body which engages in the installation portion, for example. This design makes it preferably possible, in particular after removal of the window from the foam tool, to connect the plastic base body to the at least one installation component, in particular to screw and/or swing and/or clip it into said installation component. After connecting, the plastic base body preferably nestles against the inner surface without touching it.

According to a preferred embodiment, the installation component forms an in particular sleeve-like bearing position to which the plastic base body is connected. This is advantageous in that only one bearing position of this kind must be disposed on the inner surface of the window. For example, the installation component can be formed as a bearing bush which is foamed to the inner surface of the window.

According to a preferred embodiment, the plastic base body is disposed at a distance to the inner surface because of its connection to the installation component, such that an air gap is formed between the inner surface of the window and the plastic base body. The remaining distance to the inner surface preferably prevents direct contact with said inner surface and can thus effectively prevent burns.

According to a preferred embodiment, the plastic structure has at least one pretension element, which is disposed, in particular glued to and/or foamed to and/or overmolded with, the inner surface of the window and which is configured to pretension the plastic base body with respect to the window. In other words, further geometries can be foamed to the inner surface for pretensioning.

According to a preferred embodiment, the plastic structure comprises at least one light-emitting element and/or antenna element and/or a measuring sensor and/or a communication device. Alternatively or additionally (i.e., and/or), the at least one light-emitting element and/or antenna element is disposed in, in particular enclosed by, a foam and/or overmold between the at least one window and the at least one plastic structure. In an exemplary manner, the light-emitting element can inject light into the foamed and/or overmolded structure and/or into the plastic structure, in particular the plastic base body. Alternatively or additionally, an antenna can also be integrated. Alternatively or additionally, an antenna can also be integrated. The antenna can be an electric antenna or a magnetic antenna. The measuring sensor can be, for example, a temperature sensor, a humidity sensor, a GPS sensor, an acceleration sensor and/or a comparable measuring sensor. The communication device can be a WLAN interface, an LTE interface or any other short-, medium- or long-range communication interface. The communication device enables the motor vehicle to communicate with a vehicle environment and, in particular, to transmit and/or receive data. The light-emitting element can comprise one or several light sources. The light sources are in particular configured to display a semi-autonomous or autonomous driving mode and/or different driving mode situations of the motor vehicle.

Furthermore, the invention relates to a motor vehicle comprising a vehicle body which has a body frame, which at least partially defines a roof opening and on which a peripheral supporting receptacle for receiving the window module is formed; and at least one window module according to any embodiment of the invention, which covers the roof opening at least partially and which is at least partially housed by the peripheral supporting receptacle. The body frame is not required to fully surround the roof to opening. The peripheral supporting receptacle is preferably provided in an edge portion of the body frame. The peripheral supporting receptacle preferably surrounds the roof opening at least partially. The peripheral supporting receptacle preferably serves as an installation surface for the at least one window. Depending on the design of the vehicle, the installation can be carried out from the bottom (bottom load) or from the top (top load) or from the side. In an embodiment, at least an edge portion of the at least one window is configured to be glued to and/or foam-covered and/or overmolded with at least one portion of the peripheral supporting receptacle. This serves to fasten the window module to the vehicle body.

Furthermore, the invention relates to a roof module for forming a vehicle roof on a motor vehicle comprising: a window module according to any embodiment of the invention, which at least partially forms a roof skin of the vehicle roof, which functions as an outer sealing surface of the roof module, and at least one environment sensor which is configured to send and/or receive electromagnetic signals to detect a vehicle environment. Roof modules of this kind are also known as roof sensor modules (RSM). The roof module according to the invention can form a modular unit in which features for autonomous or semi-autonomous driving assisted by driver assistance systems are integrated and which can be placed on a vehicle body shell as a unit by a vehicle manufacturer. Furthermore, the roof module according to the invention can be a purely fixed roof or a roof including a roof opening system. Moreover, the roof module can be configured for use with a passenger car or a utility vehicle. Alternatively or additionally, (i.e., and/or) it is preferred if the roof module comprises one or several see-through portion(s), for example an at least partially transparent fixed roof element in order to optimize a daylight concept in a vehicle interior. However, alternatively or additionally, a see-through portion of this kind can also be a see-through portion of an environment sensor through which the environment sensor sees, in particular through which said environment sensor can send and/or receive electromagnetic signals to detect a vehicle environment. In general, the environment sensor according to the invention can have various designs and comprise a lidar sensor, a radar sensor, an optical sensor, such as a camera or a multi-camera, an ultrasonic sensor and/or the like. Lidar sensors operate in a wavelength range of 905 nm or approximately 1550 nm, for example. A material in a see-through portion of the environment sensor is preferably transparent to a wavelength range used by the environment sensor and selected as a function of the wavelength(s) used by the environment sensor.

Of course, the embodiments and the illustrative examples mentioned above and yet to be discussed below can be realized not only individually but also in any combination with each other without departing from the scope of the present invention. Moreover, the embodiments and illustrative examples mentioned above and yet to be discussed below equivalently or at least similarly relate to the window module according to the invention without being mentioned separately in its context.

### BRIEF DESCRIPTIONS OF THE DRAWINGS

Embodiments of the invention are schematically illustrated in the drawings and are described in an exemplary manner hereinafter.

FIG. 1 shows a schematic view of a motor vehicle having a vehicle body and an embodiment of a window module;

FIG. 2 shows a schematic view of a first embodiment of the window module according to the invention;

FIG. 3 shows a sectional view of the embodiment shown in FIG. 2 of the window module according to the invention;

FIG. 4 shows a schematic view of a second embodiment of the window module according to the invention;

FIG. 5 shows a schematic view of a third embodiment of the window module according to the invention;

FIG. 6 shows a schematic view of a fourth embodiment of the window module according to the invention;

FIG. 7 shows a schematic view of a fifth embodiment of the window module according to the invention;

FIG. 8 a second schematic view of the fifth embodiment of the window module according to the invention;

FIG. 9 shows a schematic bottom view of the fifth embodiment of the window module according to the invention;

FIG. 10 shows a detailed view of the fifth embodiment of the window module according to the invention;

FIG. 11 shows a sectional view of a sixth embodiment of the window module according to the invention;

FIG. 12 shows a side view of a seventh embodiment of the window module according to the invention;

FIG. 13 shows a front view of an eighth embodiment of the window module according to the invention;

FIG. 14 shows a sectional view of a ninth embodiment of the window module according to the invention;

FIG. 15 shows a detailed view of a tenth embodiment of the window module according to the invention;

FIG. 16 shows a detailed view of an eleventh embodiment of the window module according to the invention; and

FIG. 17 shows a detailed view of a twelfth embodiment of the window module according to the invention.

### DETAILED DESCRIPTION

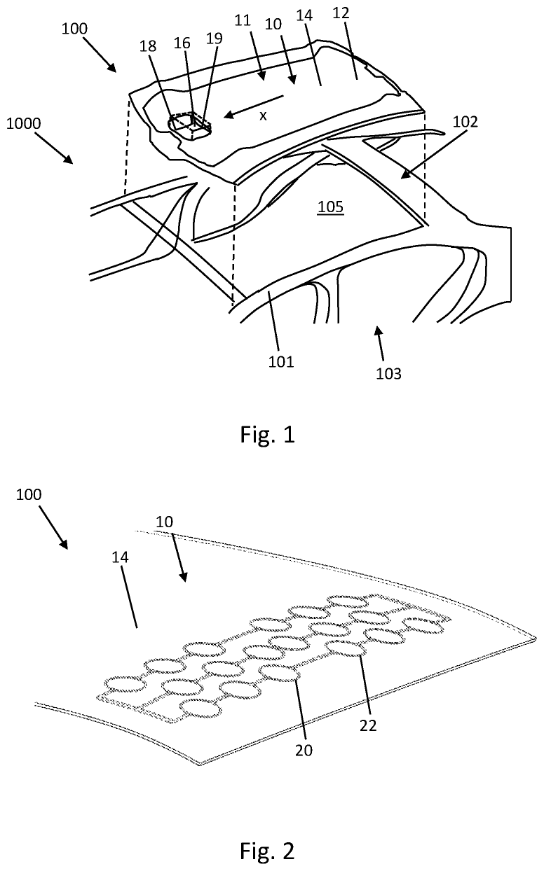

FIG. 1 shows a motor vehicle 1000 having a vehicle roof 100. In the present case, vehicle roof 100 is formed by a window module 10. Window module 10 is placed on top of a peripheral supporting receptacle 101 of a body frame 102 of a vehicle body 103, in particular foamed around and/or glued to and/or injection-molded to said body frame 102 as a structural unit, for example via its edge portion 106. In the present case, window module 10 can also be comprised by a roof module 11 which is configured to support semi-autonomous or autonomous driving using motor vehicle 1000. Window module 10 or roof module 11 covers a roof opening 105 from a vehicle environment, such that rain is prevented from entering, for example. Window module 10 is configured as a fixed transparent window module, which is also referred to as fixed transparent module, FTM for short. Window module 10 or roof module 11 at least partially forms a roof skin 12 of vehicle roof 100, which functions as an outer sealing surface.

Window module 10 comprises at least one at least partially transparent window 14, which forms a fixed panoramic roof in the present case. Window 14 has an outer surface facing a vehicle environment and an inner surface opposite the outer surface and facing a vehicle interior. In an exemplary manner, at least one environment sensor 16 is disposed on the outer surface in the present case, said environment sensor 16 being configured to send and/or receive electromagnetic signals in order to detect a vehicle environment. Environment sensor 16 is comprised in a sensor housing 18, which has a see-through portion 19 though which environment sensor 16 sees in order to detect the vehicle environment.

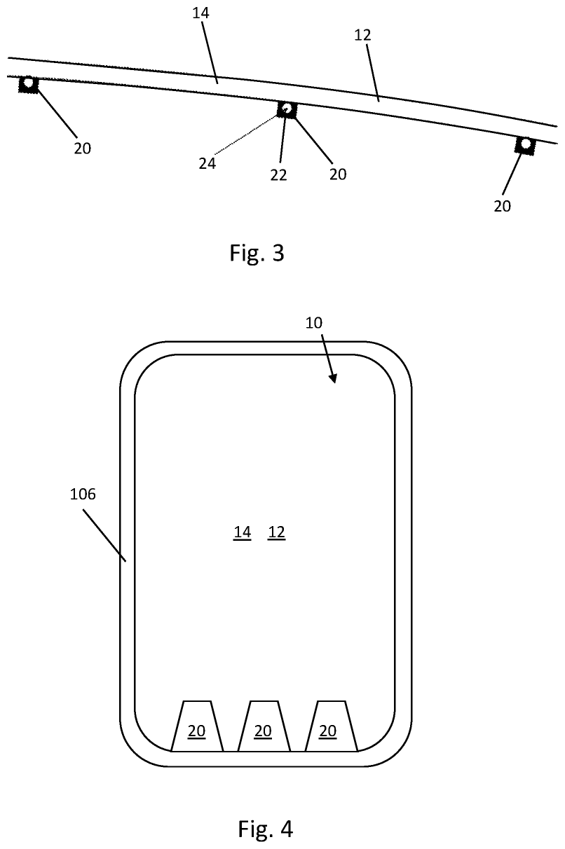

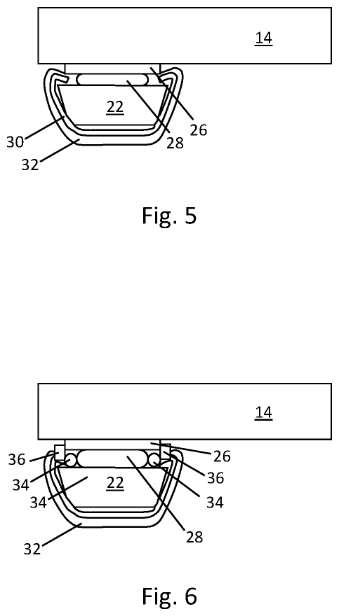

According to the invention, at least one plastic structure 20, which is at least configured as a burn protection for at least one vehicle occupant, is disposed on the inner surface of window 44. Plastic structure 20 has a lower thermal conductivity compared with the at least one window. Plastic structure 20 is glued to the inner surface of at least one window 14 (cf. FIGS. 5 and 6) and/or disposed on the inner surface, in particular connected to said inner surface, by foaming (cf. FIGS. 2 and 3) and/or overmolding.

Generally, plastic base body 22 can be dimensioned and/or formed in various ways. Preferably, plastic base body 22 is duct-shaped and/or rib-shaped, as can be seen in schematic view in FIG. 2, for example. The duct-shaped design, i.e., providing a cavity 24 within plastic base body 22 is schematically illustrated in FIG. 3. For example, plastic structure 20 can be formed honeycomb-like, as shown in FIG. 2, such that an ideal ergonomic protection against contact is provided.

Plastic base body 22 can preferably be glued to a frit 26 by means of a gluing agent, said frit 26 being formed on window 14. The gluing agent preferably forms an adhesive layer 28 between frit 26 and plastic base body 22, as can be seen in FIGS. 5 and 6. Preferably, a foam layer 30 and/or a textile layer 32 can also be applied to or on plastic base body 22 (cf. FIGS. 5 and 6), in particular glued to said plastic base body 22. Each additional layer is preferably laminated on plastic base body 22 via an adhesive layer, which can be applied in particular by means of a spray glue. Through this, in particular through an additional foam layer 30, plastic base body 22 can also function as impact protection. In terms of a color, structure, pattern and/or functional effect of the plastic base body, it is generally also possible to provide at least one film, which is preferably introduced into plastic base body 22 by an in-mold lamination process (not shown).

It can also be preferred if at least one light-emitting element and/or antenna element and/or a measuring sensor and/or a communication device is/are disposed in, in particular enclosed by, a foam and/or overmold between at least one window 14 and at least one plastic structure 20. Particularly preferably, plastic structure 20 comprises at least one light-emitting element and/or antenna element and/or a measuring sensor and/or a communication device of this kind (see FIG. 6). FIG. 6 shows a light-emitting element 34 in an exemplary manner. Light-emitting element 34 can be an LED circle, for example. Light-emitting element 34 can send electromagnetic radiation in the form of, in particular, visible light, into an environment through a glazing 36 provided on plastic structure 20, for example.

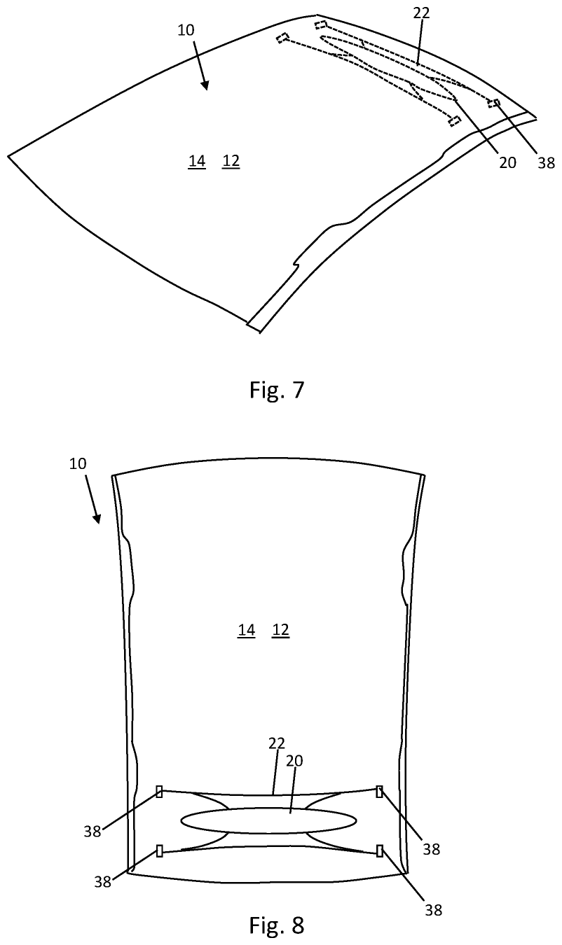

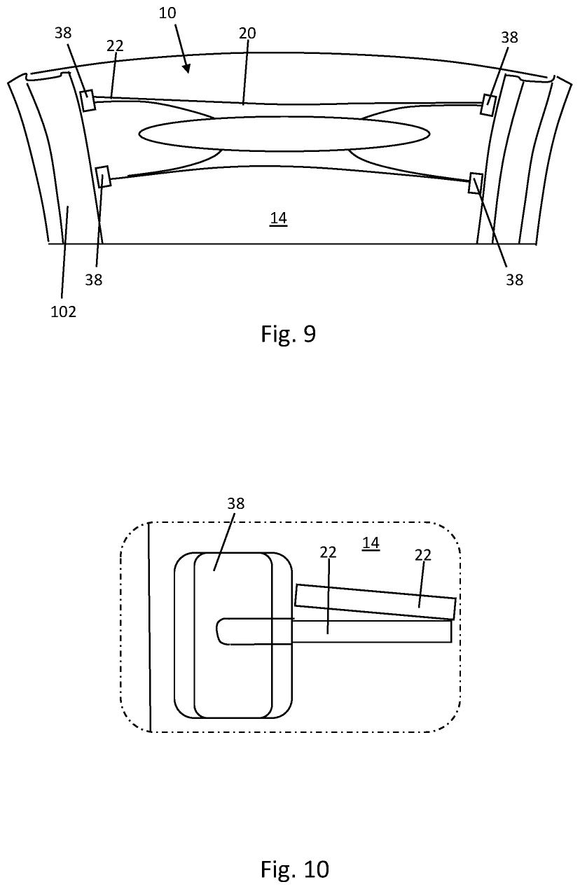

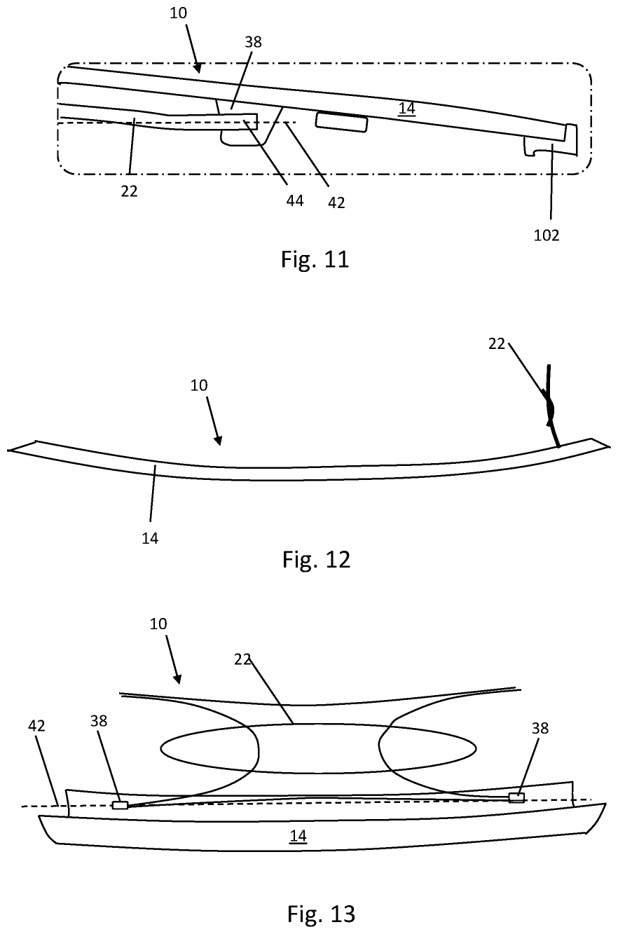

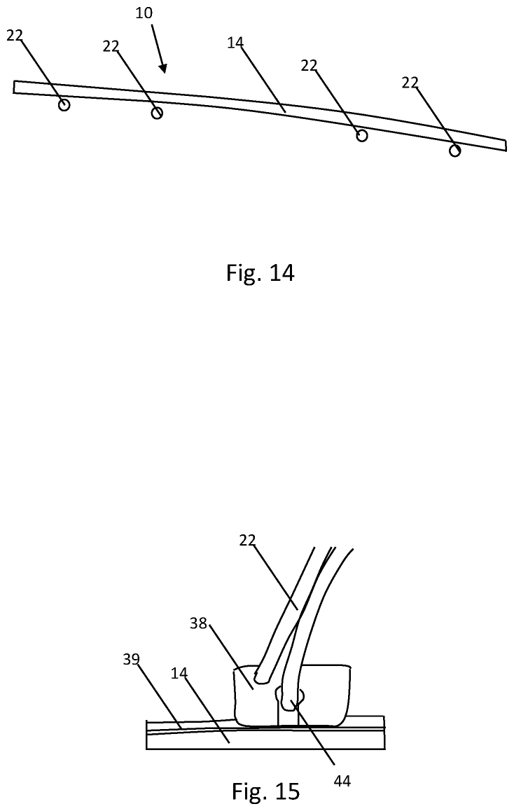

In an alternative or additional embodiment, it can also be preferred if plastic base body 22 is disposed on the inner surface of window 44 via an installation component 38. Illustrative examples of this kind are shown in FIGS. 7 to 17 and are described in more detail below. In an arrangement of this kind, plastic base body 22 is disposed at a distance to the inner surface of window 44 because of the interposition of the installation component in the installed state (see FIGS. 11, 16 and 17).

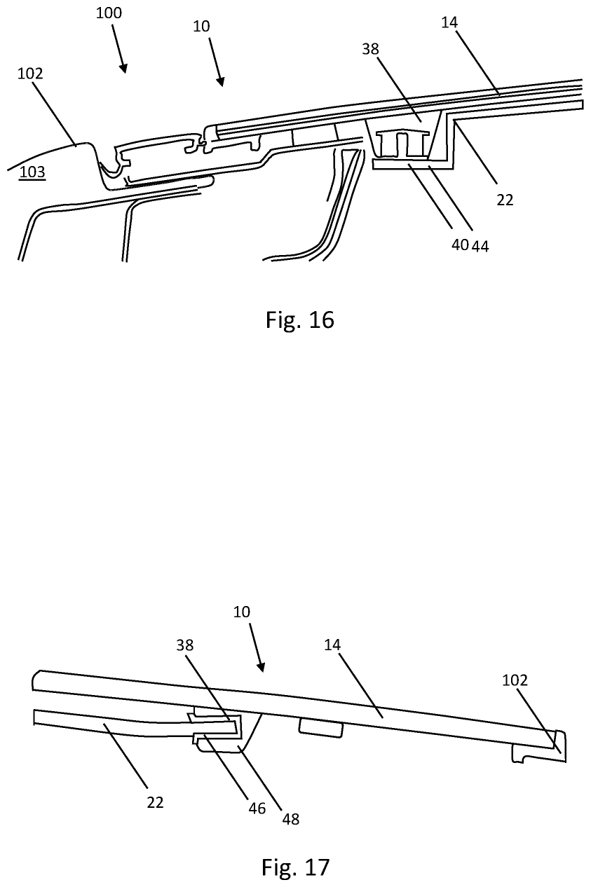

Installation component 38 is glued to (see for example adhesive layer 39 in FIG. 15) the inner surface of the at least one window 14 and/or screwed to and/or disposed on, in particular connected to, the inner surface by foaming and/or overmolding. Installation component 38 is configured to receive plastic base body 22 at least partially, in particular captively (see FIGS. 10, 11 and 15 to 17). Plastic base body 22 can also be connected to installation component 38 via a screwed connection 40, as can be seen in FIG. 16. Plastic base body 22 is preferably housed in installation component 38 such that it is pivotable around a pivot axis 42, preferably at least on one side, in order to facilitate its installation. For example, plastic base body 22, which is formed in particular grid-like according to FIGS. 7 to 17, can be connected to installation component 38 via a respective free end or installation end portion 44. For example, a hinged connection is possible, in which a socket is formed on installation component 38, and installation end portion 44 has a hinge portion complementary thereto. Preferably, several end portions of plastic base body 22 can be connected to the inner surface of window 44 via one installation component 38 each. Plastic base body 22 is in particular captively connected to the at least one installation component 38, preferably via a clip connection or a hinged connection and/or screwed connection 40.

Installation component 38 can also form an in particular sleeve-like bearing position 46 to which plastic base body 22 is connected (see FIG. 17). This allows a simple push-fit connection between plastic base body 22 and installation component 38. Furthermore, only bearing position 46 must be disposed on the inner surface of window 44. For example, bearing position 46 is over-molded by a plastic material, in particular polyurethane. Overmold 48 also connects bearing position 46 to the inner surface of window 44.

1. A fixed transparent window module, for being fitted on a vehicle body, which has a body frame by means of which a roof opening is defined at least partially and on which a peripheral supporting receptacle for receiving the window module is formed, comprising:
at least one at least partly transparent window, which has an outer surface facing a vehicle environment and an inner surface opposite the outer surface and facing a vehicle interior,
wherein at least one plastic structure, which is at least configured as a burn protection for at least one vehicle occupant, is disposed on the inner surface.

2. The window module according to claim 1, wherein the at least one plastic structure has a lower thermal conductivity compared with the at least one window.

3. The window module according to claim 1, wherein the at least one plastic structure is glued to the inner surface of the at least one window and/or connected to said inner surface, by foaming and/or overmolding.

4. The window module according to claim 1, wherein at least one frit, on which the at least one plastic structure is disposed, is formed on the inner surface of the at least one window.

5. The window module according to claim 1, wherein the inner surface of the at least one window comprises at least a partially pretreated portion on which the at least one plastic structure is disposed.

6. The window module according to claim 1, wherein the at least one plastic structure is made of a recycled plastic and/or a natural plastic and/or a thermoplastic elastomer and/or polyurethane and/or silicone.

7. The window module according to claim 1, wherein the at least one plastic structure comprises a plastic base body which is at least partially transparent.

8. The window module according to claim 7, wherein the plastic base body is perforated and/or foam-filled and/or comprises a guide structure which is structurally stable, over-molded by plastic.

9. The window module according to claim 7, wherein the plastic base body comprises at least one film which is introduced into said base body by an in-mold lamination process.

10. The window module according to claim 9, wherein the at least one film has a pattern and/or a coloring and/or an optical filter characteristic.

11. The window module according to claim 7, wherein a foam layer and/or a textile layer is/are applied to the plastic base body said plastic base body.

12. The window module according to claim 7, wherein the plastic base body is produced using injection molding and/or deep drawing, and/or 3D printing.

13. The window module according to claim 7, wherein the plastic base body is rib-shaped and/or duct-shaped and/or grid-shaped.

14. The window module according to claim 7, wherein the plastic structure has at least one installation component which is glued and/or screwed to the inner surface of the at least one window and/or connected to, the inner surface by foaming and/or overmolding and which is configured to receive the plastic base body at least partially, captively.

15. The window module according to claim 7, wherein the plastic base body is in captively connected to the at least one installation component via a clip connection and/or a hinged connection.

16. The window module according to claim 7, wherein the installation component forms a sleeve-like bearing position to which the plastic base body is connected.

17. The window module according to claim 14, wherein the plastic base body is disposed at a distance to the inner surface because of its connection to the installation component, such that an air gap is formed between the inner surface of the window and the plastic base body.

18. The window module according to claim 14, wherein the plastic structure has at least one pretension element, which is disposed on and/or foamed to and/or overmolded with, the inner surface of the window and which is configured to pretension the plastic base body with respect to the window.

19. The window module according to claim 1, wherein the plastic structure comprises at least one light-emitting element and/or antenna element and/or a measuring sensor and/or a communication device, and/or in that the at least one light-emitting element and/or antenna element and/or the measuring sensor and/or the communication device is/are enclosed by a foam and/or overmold between the at least one window and the at least one plastic structure.

20. A motor vehicle comprising: a vehicle body which has a body frame, which at least partially defines a roof opening and on which a peripheral supporting receptacle is formed; and at least one window module according to claim 1, which covers the roof opening at least partially and which is at least partially housed by the peripheral supporting receptacle.

21. The motor vehicle according to claim 20, wherein at least an edge portion of the at least one window is configured to be glued to and/or foam-covered and/or overmolded with at least a portion of the peripheral supporting receptacle.

22. A roof module for forming a vehicle roof on a motor vehicle comprising: a window module according to claim 1 which at least partially forms a roof skin of the vehicle roof, which functions as an outer sealing surface of the roof module, and at least an environment sensor which is configured to send and/or receive electromagnetic signals to detect a vehicle environment.
